(19) United States
(12) Patent Application Publication
(10) Pub. No.: US 2019/0001650 A1
(43) Pub. Date: Jan. 3, 2019

(54) REINFORCED POLYMER LAMINATE

(71) Applicant: SABIC Global Technologies B.V., Bergen op Zoom (NL)

(72) Inventors: Sungkyun SOHN, Longmeadow, MA (US); Stanley Leroy LAWRENCE, Adams, MA (US); Erich Otto TEUTSCH, Richmond, MA (US)

(21) Appl. No.: 16/064,354

(22) PCT Filed: Dec. 20, 2016
(86) PCT No.: PCT/US2016/067682

§ 371 Date: Jun. 20, 2018

Related U.S. Application Data
(60) Provisional application No. 62/387,142, filed on Dec. 23, 2015.

(51) Int. Cl. B32B 27/34; B32B 5/24; B32B 27/36; B32B 27/12; B32B 27/08

(52) U.S. Cl. CPC B32B 27/34; B32B 5/24; D06M 15/59; B32B 27/12; B32B 27/08; B32B 27/365

(57) ABSTRACT

A polymer laminate and a method for manufacturing a polymer laminate are disclosed. The polymer laminate includes a first layer having a first surface and a second surface. The first layer includes a first non-porous polymer material. The polymer laminate also includes a second layer on the first surface of the first layer. The second layer includes a first porous polymer material defining a first plurality of pores, and the first non-porous polymer material located within the first plurality of pores.

### TECHNICAL FIELD

This disclosure pertains generally, but not by way of limitation, to a laminate, and more particularly, to a reinforced polymer laminate.

### BACKGROUND

Reinforced polymer laminates have many applications in different industries. Traditionally, some reinforced polymer laminates are made through a wet-laid papermaking process. A mixture of synthetic polymer fibers is suspended in water. The polymer fiber and water mixture is applied to a surface to form a web of polymer fibers. Water is removed through heating and/or drying processes.

However, it is difficult to make a thin, high-strength paper that can be further processed to produce products, such as a honeycomb structure using traditional wet-laid processes. Because of the thin layers, reinforcement is made without attention to separate reinforcement layers. It is also difficult to provide good adhesion to a variety of different substrates with or without the use of adhesives. It may also be challenging to control adhesion between reinforcement layers and the polymer matrix to provide optimal tear resistance. Other techniques attempt to meet the required mechanical properties by dipping in pre-polymer and curing. However, these processes require additional cost, weight, and processing time. It also becomes problematic to control the stiffness of the polymer laminate.

One such application for polymer laminates is for use in semi-structural panels for aircraft interiors. The semi-structural panels in aircraft are often made in part from honeycomb sheets to meet strength and weight requirements of the aircraft. To produce honeycomb sheets, thin, high-strength paper is first made from fire-resistant polymers. The fire-resistant polymers often need to be reinforced to provide additional strength to the polymer laminate. It is difficult to produce polymer laminates that meet these requirements with the methods known in the art.

Accordingly, there is a need for an improved polymer laminate to address the aforementioned problems and/or other problems known in the art.

### OVERVIEW

According to one aspect, a polymer laminate includes a first layer having a first surface and a second surface, the first layer comprising a first non-porous polymer material, and a second layer on the first surface of the first layer, the second layer includes a first porous polymer material defining a first plurality of pores, and the first non-porous polymer material located within the first plurality of pores.

According to another aspect, a method for manufacturing a polymer laminate includes arranging a first layer having a first surface and a second surface, the first layer comprising a first non-porous polymer material, arranging a second layer on the first surface of the first layer, the second layer comprising a first porous polymer material defining a first plurality of pores, heating the first layer to a temperature above a glass transition temperature of the first non-porous polymer material, applying pressure to the first surface of the first layer, and filling the first plurality of pores with the first non-porous polymer material.

According to another aspect, a polymer laminate includes a first layer comprising a first porous polymer material defining a first plurality of pores, and a second layer comprising a second porous polymer material defining a second plurality of pores, wherein the first porous polymer material is located within the second plurality of pores, and wherein the second porous polymer material is located within the first plurality of pores.

Additional aspects of the disclosure will be set forth in part in the description which follows, and in part will be obvious from the description, or can be learned by practice of the disclosure. The advantages of the disclosure will be realized and attained by means of the elements and combinations particularly pointed out in the appended claims. It is to be understood that both the foregoing general description and the following detailed description are exemplary and explanatory only and are not restrictive of the disclosure as recited herein.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various aspects discussed in the present disclosure.

FIG. 1 illustrates a polymer laminate according to a first aspect of the present disclosure.

FIG. 2 illustrates a polymer laminate according to a second aspect of the present disclosure.

FIG. 3 illustrates a polymer laminate according to a third aspect of the present disclosure.

FIG. 4 illustrates a polymer laminate according to a fourth aspect of the present disclosure.

FIG. 5 illustrates a polymer laminate according to a fifth another aspect of the present disclosure.

FIG. 6 illustrates a polymer laminate according to a sixth aspect of the present disclosure.

FIG. 7 illustrates a polymer laminate according to a seventh aspect of the present disclosure.

### DETAILED DESCRIPTION

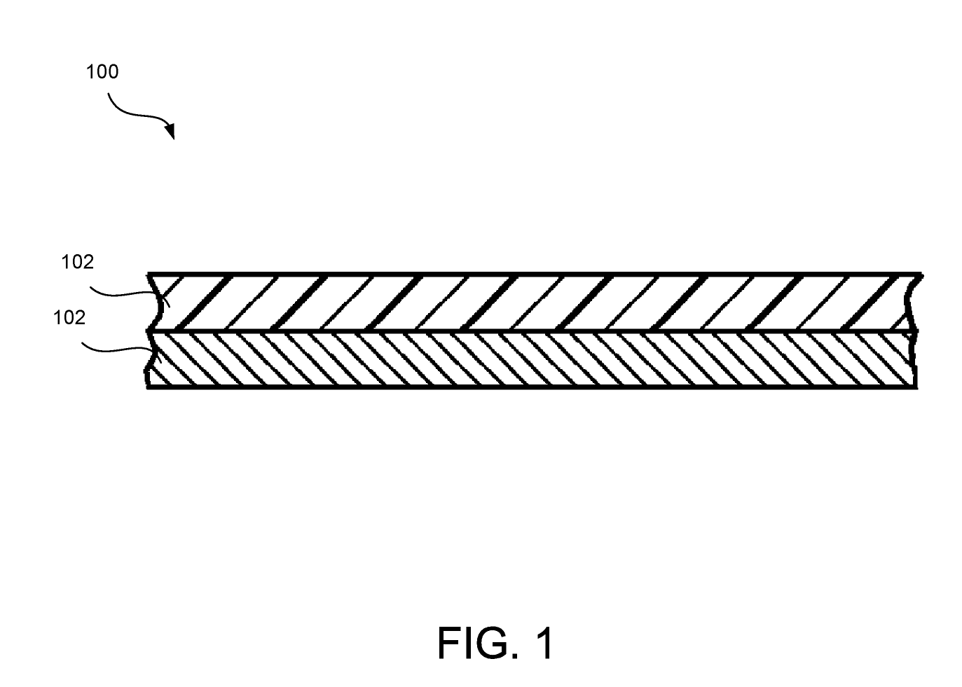

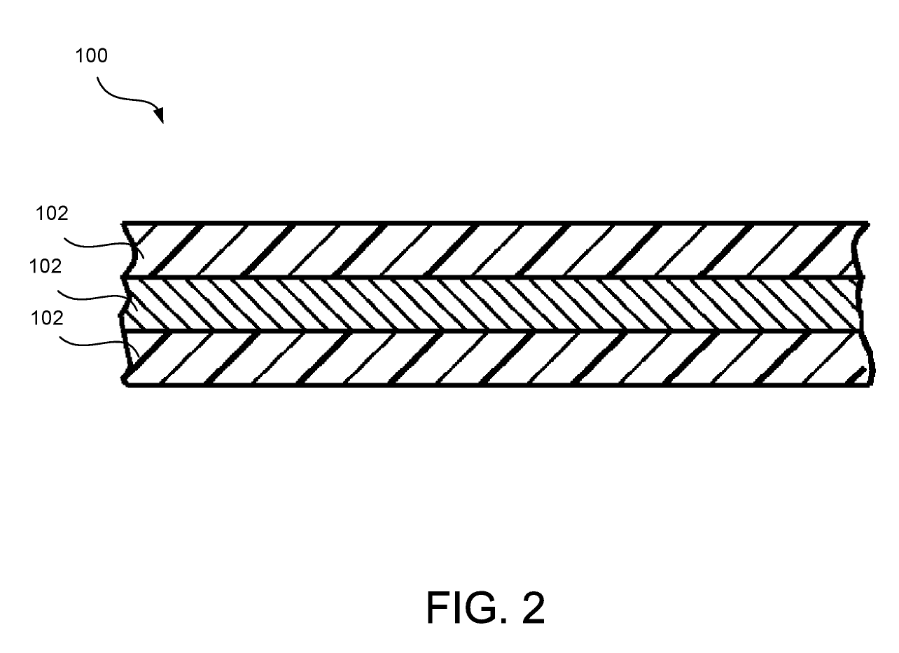

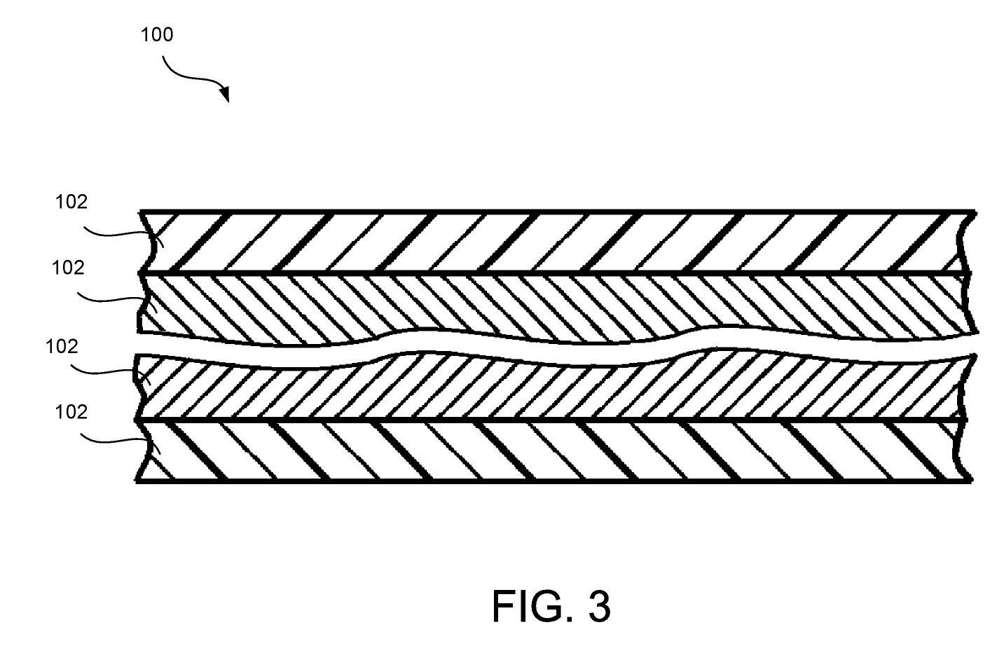

FIGS. 1, 2, and 3 illustrate a polymer laminate 100 according to an aspect of the present disclosure. The polymer laminate 100 is a composite polymer laminate that may be made from a plurality of layers 102. As shown in FIGS. 1, 2, and 3, the polymer laminate 100 may be made with two, three, and/or four or more layers 102.

The layers 102 may have a woven or non-woven construction. Woven layers may be produced by interlacing fibers in a pattern. Some patterns may include one or more of a plain weave, a twill weave, a satin weave, a basket weave, a leno weave, a mock leno wave, and the like. Different weaves may have different stability, drape, porosity, smoothness, symmetry, crimp, and other properties that may be desirable depending on the application of the polymer laminate 100. Possible non-woven constructions of the layers 102 include a film, a knit, a veil, a paper, a felt, and the like. The layers 102 may include impregnation with a binder to provide for additional bonding between the fibers. In one aspect, one or more of the layers 102 may have a different disclosed construction. In one aspect, one or more the layers 102 may have a different disclosed material. In one aspect, one or more of the layers 102 may have a different disclosed construction and one or more the layers 102 may have a different disclosed material.

A film layer may be formed using a number of different manufacturing methods including extrusion, solution casting, polymer dispersion, spin coating, calendaring, and the like. An extrusion process may be suitable in cases in which the material selected for the layer 102 does not undergo thermal degradation upon transition to a state of viscous flow. An extruder with an annular or slit head may be used for an extrusion process. With an annular head, the polymer material is heated and extruded in the form of a tube, which is inflated by compressed air and leading to a biaxial orientation of the film. With the slit head, also known as the slot-die method or slot-extrusion method, the extrusion may be formed with unoriented (isotropic), uniaxially oriented, and biaxially oriented polymer films. The polymer films formed by these processes may be subsequently smoothed by rolls to produce a film of uniform thickness with a high-quality surface.

For a polymer solution casting process, a mandrel or inner diameter mold may be immersed in a tank of polymer solution that has been specifically engineered for the process. Due to a combination of thermal and frictional properties, the polymer solution then forms a thin film around the mold. The mold is then extracted from the tank in a precisely controlled manner, followed by a curing or drying process. Once the first layer of thin film is appropriately solidified, secondary features can be added to the product such as braided or coiled wire, laser-cut hypotubes or engineered metal reinforcements to prevent kinking, or imaging targets specific to the intended application. Multiple casting steps can then be repeated to encapsulate the reinforcements and build up wall thickness. The film is then removed from the mold after it is cured or solidified.

For a calendaring process, a machine may be used to press a heated polymer material between two or more rollers to form a continuous film. To begin the process, the polymer may undergo blending and fluxing to reach the desired material composition and consistency for the calendaring machine to handle. The polymer material is then pressed between two or more rollers to decrease a thickness of the material and produce a film. The polymer material may be fed into multiple sets of rollers of decreasing gap to produce a thinner film. The last set of rollers may also be used to produce desired properties for the surface finish, such as the glossiness and texture of the film surface.

In some aspects, the layers 102 may be a knit formed from long fibers and stitched into rows of interlocking loops. The knit may be a weft knit where the columns of loops are perpendicular to the course of the yarn or a warp knit where the columns of loops are roughly parallel to the course of the yarn. In other aspects, the layers 102 may be a veil, paper, and/or felt produced by matting, condensing, and pressing fibers together, such as through a dry-laid process, an air-laid process, a spun-laid process, a wet-laid process, and the like.

For a dry-laid process, bales of fibers may be blended and conveyed to a next stage by air transport. The fibers then may be combed into a web by a carding machine, which is a rotating drum or series of drums covered in fine wires or teeth. The precise configuration of cards will depend on the fabric weight and fiber orientation required. The web may be parallel-laid, where most of the fibers are laid in the machine direction, or they can be random-laid. Typical parallel-laid carded webs may result in good tensile strength, low elongation, and low tear strength in the machine direction and the reverse in cross direction. Relative speeds and web composition may be varied to produce a wide range of properties.

For an air-laying process, the fibers selected may have a relatively short length. The fibers may be fed into an air stream and transported to a moving belt or perforated drum, where the fibers may form a randomly oriented web. Compared with carded webs in the dry-laid process, air-laid webs may have a lower density, a greater softness and an absence of laminar structure. Airlaid webs may offer more flexibility in terms of the fiber blends that can be used.

For a spun-laid process, polymer granules may be melted and molten polymer is extruded through spinnerets to form filaments. The filaments may be cooled and deposited on to a conveyer to form a uniform web. Co-extrusion of second components may be used in a multi-step spun-laid process to provide extra properties or bonding capabilities. The spun-laid process may produce a non-woven material with higher strength, but fewer materials may be compatible with this process.

For a wet-laid process, a dilute slurry of water and fibers may be deposited on a moving or stationary wire screen and drained to form a web. The web may be de-watered, consolidated by pressing between rollers, and dried. Impregnation with binder may be included to provide for additional bonding between the fibers. A non-woven formed by a wet-laid process web may allow for a wide range of fiber orientations ranging from near random to near parallel. The strength of the random oriented web is rather similar in all directions in the plane of the fabric. A wide range of natural, mineral, synthetic and man-made fibers of varying lengths may be used for a wet-laid process.

The layers 102 may have an areal density between 5 and 100 grams per square meter (gsm). The layers 102 may have an areal density between 2 and 400 grams per square meter (gsm). The areal density of the layers 102 may be between 2 and 5 gsm, 5 and 10 gsm, 10 and 15 gsm, 15 and 20 gsm, 20 and 25 gsm, 30 and 35 gsm, 35 and 40 gsm, 40 and 45 gsm, 45 and 50 gsm, 50 and 55 gsm, 55 and 60 gsm, and the like.

The layer 102 may be made from at least one thermoplastic resin. Specific non-limiting examples of suitable thermoplastic resins include polyacetal, polyacrylic, styrene acrylonitrile, acrylonitrile-butadiene-styrene (ABS), a polyester (such as an aromatic polyester, polybutylene terephthalate (PBT), polyethylene terephthalate (PET), and the like), polycarbonate (PC), polystyrene, polyethylene, polyphenylene ether, polypropylene, Nylons (Nylon-6, Nylon-6/6, Nylon-6/10, Nylon-6/12, Nylon-11 or Nylon-12, for example), polyamide (PA), polyamide-imide, polyarylate, polyurethane, ethylene propylene diene rubber (EPR), ethylene propylene diene (EPDM), polyarylsulfone, polyethersulfone, polyphenylene sulfide, polyvinyl chloride, polysulfone, polyetherimide (PEI), polytetrafluoroethylene, fluorinated ethylene propylene, perfluoroalkoxyethylene, polychlorotrifluoroethylene, polyvinylidene fluoride, polyvinyl fluoride, polyetherketone, polyether ether ketone (PEEK), liquid crystal polymers and mixtures comprising any one of the foregoing thermoplastics.

The thermoplastic resin may also be propriety resin materials, such as LEXAN™, which is a polycarbonate based resin, VECTRAN™, which is an aromatic polyester produced by polycondensation of 4-hydroxybenzoic acid and 6-hydroxynaphthalene-2-carboxylic acid, ULTEM™, which is a polyetherimide (PEI) resin, Noryl GTX™, which is a blend of polyamide (PA) and modified polyphenylene ether (PPE), or Thermocomp RC008™, which is a Nylon 66 resin. It is anticipated that any thermoplastic resin may be used in the present disclosure that is capable of being sufficiently softened by heat to permit fusing and/or molding without being chemically or thermally decomposed.

The material selected for the layers 102 may include at least one type of fiber material designed to help provide strength to the polymer laminate 100. Fibers suitable for use in the disclosure include glass fibers, carbon fibers, graphite fibers, synthetic organic fibers, particularly high modulus organic fibers such as para- and meta-aramid fibers, nylon fibers, polyester fibers, polycarbonate (PC) fibers, or any of the thermoplastic resins mentioned above that are suitable for use as fibers, natural fibers such as hemp, cotton, bamboo, sisal, jute, flax, coir, kenaf and cellulosic fibers, mineral fibers such as basalt, mineral wool (e.g., rock or slag wool), Wollastonite, alumina silica, and the like, or mixtures thereof, metal fibers, metalized natural and/or synthetic fibers, ceramic fibers, or mixtures thereof. In one aspect, the fibers selected for the reinforcing layer include carbon fibers and aramid fibers. In one aspect, the fibers selected for the reinforcing layer include carbon fibers. In one aspect, the fibers selected for the reinforcing layer include aramid fibers. In one aspect, the fibers selected for the reinforcing layer include polycarbonate (PC) fibers. In one aspect, the fibers selected for the reinforcing layer include aromatic polyester fibers, such as VECTRAN™ fibers and polycarbonate fibers, such as LEXAN™ fibers.

In other aspects, the fibers may be nano-fibers. As used herein, the term nanofiber refers generally to an elongated fiber structure having an average diameter ranging from less than 50 nm to 5000 nm or greater. In some examples, the average diameter may range from 40 nm to 5000 nm. The “average” diameter may take into account not only that the diameters of individual nanofibers making up a plurality of nanofibers formed by implementing the presently disclosed method. The average density may vary somewhat, but the diameter of an individual nanofiber may not be uniform over its length in some implementations of the disclosure. In various examples, the average length of the nanofibers may be as high as millions of nm. In various examples, the aspect ratio (length/diameter) of the nanofibers may be as high as millions. In some aspects, nanofibers with aspect ratios of at least 10,000 may be utilized. Insofar as the diameter of the nanofiber may be on the order of a few microns or less, for convenience the term “nanofiber” as used herein encompasses both nano-scale fibers and micro-scale fibers (microfibers). The nano-fibers may be formed from any of the organic and inorganic materials mentioned above.

In this regard, an apparatus or system as set forth below may be utilized for fabricating the nanofibers. The apparatus generally includes a container for containing a volume of dispersion medium and receiving polymer solution, a structure extending out from the container, and a dispensing device for supplying the polymer solution to the dispersion medium. The dispensing device may be of any suitable type for introducing the polymer solution (optionally with additives) into the dispersion medium from a suitable supply source. The container and the structure may be configured such that they both provide surfaces cooperatively defining the boundaries of the volume of the dispersion medium, and such that the container and/or the structure move. That is, the container serves as an outer boundary or surface and the structure serves as an inner boundary or surface, at least one of which moves relative to the other to effect shearing. In the present example, the container is a stationary outer cylinder and the structure is an inner cylinder extending upward from the inside bottom of the outer cylinder in a concentric arrangement along its center axis. The outer cylinder and the inner cylinder cooperatively define an annular cylindrical interior containing the dispersion medium. The inner cylinder is driven by a suitable motor to rotate at a desired angular velocity about the center axis. The polymer solution supplying device may be any suitable conduit or applicator that dispenses the polymer solution from its tip by any operating principle (e.g., pumping action, capillary action, etc.). Rotation of the inner cylinder relative to the stationary outer cylinder imparts a shear stress to the components contained in the outer cylinder. By way of example, a polymer solution being dispensed into the outer cylinder as droplets and dispersed-phase components of the polymer solution undergoing shear in the dispersion medium, causes polymer solvent to diffuse out from the dispersed-phase components into the dispersion medium. Other methods of forming nanofibers are contemplated as well.

The fibers selected for one or more of the layers 102 may be continuous fibers or chopped fibers. The chopped polymeric fibers may be short-chopped fibers or long-chopped fibers. Generally, short-chopped fibers may have an average length of 2 millimeter (mm) or less, such as 1 mm. In contrast, long-chopped fibers may have an average length of 2 mm or more. For example, in some aspects, the long-chopped fibers may have an average length of 5 mm or greater, or 10 mm or greater. The fibers can be formed into woven or nonwoven layer through one of the processes described above.

The layers 102 may be a composite material made from the thermoplastic resin and fibers mentioned above. During manufacturing, the fibers may be formed into sheets and impregnated with the thermoplastic resin to form the composite material. The fiber content in the composite may be between 10% to 50% by weight, for example. The fiber content may be within the range of 10% to 20%, 20% to 30%, 30% to 40%, or 40% to 50% by weight. In one aspect, the first composite material is a continuous carbon-fiber impregnated with a blend of polyamide and modified polyphenylene ether polymer.

In addition to the materials described above, one or more of the layers 102 may include additional fillers. Non-limiting examples of other fillers which may be included are glass fibers, mica, talc, clay, silica and Wollastonite. Minor amounts of other materials may also be included to modify specific properties of the composition. For example, polytetrafluoroethylene (PTFE) in amounts of up to about 1% may be included as part of a flame retardant package. Other types of flame retardant packages including brominated flame retardant polymers (e.g., brominated PC) or phosphorus-containing organic flame retardants (such as resorcinol diphosphate, bisphenol A diphosphate or tetraxylyl piperazine diphosphamide) may also be included in effective amounts up to about 30%. PTFE may also be included in larger amounts, up to about 25%, to improve wear resistance; and polyethylene may be included in amounts up to about 2% to improve mold release characteristics. Impact modifiers such as styrene-butadiene-styrene (SBS) may be included in amounts up to about 10% to improve impact strength. Flow promoters such as hydrogenated polyterpene may also be included in amounts up to about 15%.

The layers 102 may also include a conductive filler. Suitable conductive fillers include solid conductive metallic fillers or inorganic fillers coated with a solid metallic filler. These solid conductive metal fillers may be an electrically conductive metal or alloy that does not melt under conditions used when incorporating them into the polymeric resin, and fabricating finished articles therefrom. Metals such as aluminum, copper, magnesium, chromium, tin, nickel, silver, iron, titanium, and mixtures including any one of the foregoing metals may be incorporated into the thermoplastic resin as solid metal particles. Physical mixtures and true alloys such as stainless steels, bronzes, and the like, can also serve as metallic constituents of the conductive filler particles herein. In addition, a few intermetallic chemical compounds such as borides, carbides, and the like, of these metals (e.g., titanium diboride) may also serve as metallic constituents of the conductive filler particles herein.

One or more of the layers 102 may be combined by or subjected to a number of different processes including heating and pressurization, lamination, calendar rolling, double belt pressing, overmolding, insert molding, injection molding, coating, ultraviolet (UV) bonding, ultrasonic bonding, and the like.

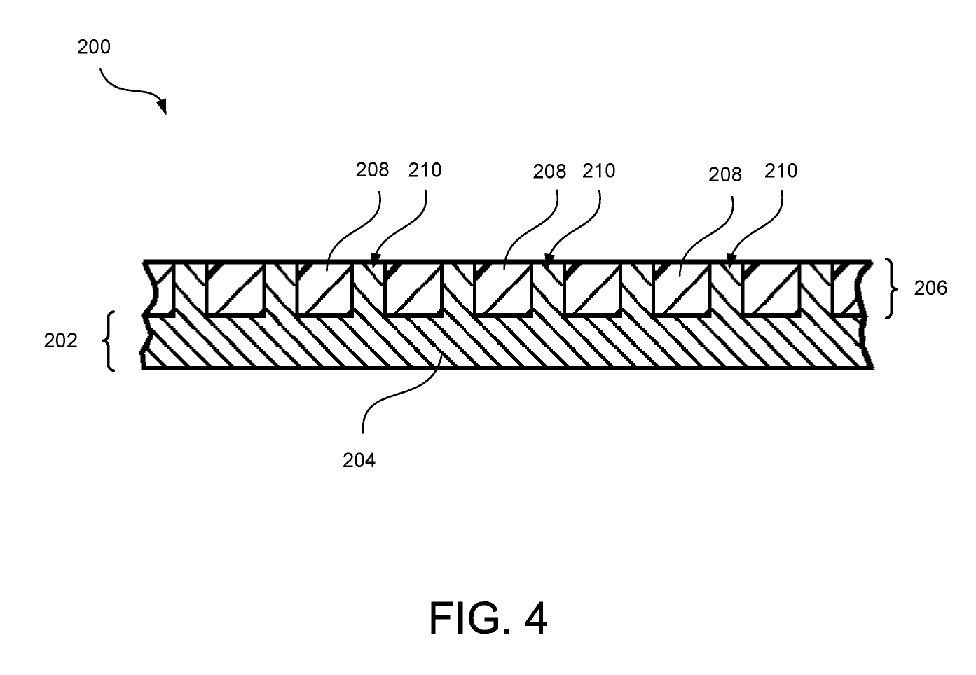

FIG. 4 illustrates a polymer laminate 200 according to an aspect of the disclosure. The polymer laminate 200 may have an areal density that may be between 2 and 500 gsm. The polymer laminate 200 may have an areal density that may be between 5 and 200 gsm The polymer laminate 200 includes at least one layer 202 comprising a polymer film 204 and at least a second layer 206 comprising a porous reinforcing layer 208 and the polymer film 204 may be further located within the pores 210 of the porous reinforcing layer 208.

The polymer film 204 may be made from at least one of thermoplastic resins mentioned above. The material selected for the polymer film 204 may depend on the intended application of the polymer laminate 200. For example, polyetherimide has properties that are desirable for applications in semi-structural panels for aircraft interiors. Polyetherimide has excellent stability of physical and mechanical properties at elevated temperatures due to a relatively high glass transition temperature. Polyetherimide also has good strength and predictable stiffness among amorphous thermoplastic materials. Further, polyetherimide has inherent flame resistance without the need for additives, may be more difficult to ignite due to a limiting oxygen index, generates low smoke per the National Bureau of Standards (NBS) smoke evolution test, and has relatively non-toxic combustion products.

In one aspect, the polymer laminate 200 may have a polymer film 204 made from polyetherimide, such as ULTEM™, or polyether ether ketone. The polymer laminate 200 may also have a porous reinforcing layer 208 made from woven or non-woven carbon fibers and/or aramid.

In a further aspect, the polymer laminate 200 may have a polymer film 204 made from polycarbonate. The polymer laminate 200 may also have a porous reinforcing layer 208 made from a woven or non-woven polyamide, such as a polyamide fabric.

In yet another aspect, the polymer laminate 200 may have a polymer film 204 made from polycarbonate, such as LEXAN™, and/or polyurethane. The polymer laminate 200 may also have a reinforcing layer made from an aromatic polyester, such as VECTRAN™.

In yet another aspect, the polymer laminate 200 may have a polymer film 204 made from polycarbonate, such as LEXAN™, and/or polyurethane. The polymer laminate 200 may also have a reinforcing layer made from an aromatic polyester, such as VECTRAN™, and a polycarbonate, such as LEXAN™. In yet another aspect, the polymer laminate 200 may have a polymer film 204 made from polycarbonate, such as LEXAN™, and/or polyurethane. The polymer laminate 200 may also have a nonwoven reinforcing layer made from fibers including an aromatic polyester, such as VECTRAN™, and a polycarbonate, such as LEXAN™.

To bond the reinforcing layer 208 to the polymer film 204, the reinforcing layer 208 may be applied to a top surface of the polymer film 204. The combined polymer film 204 and reinforcing layer 208 may be heated to a temperature above a glass-transition temperature of the thermoplastic resin selected for the polymer film 204. For example, if the thermoplastic resin is polyetherimide with a glass transition temperature of 217 the combined polymer film 204 and reinforcing layer 208 may be heated to 250° C. Heating may be implemented by one of the above-mentioned processes. In the glass transition phase, the material transitions from a hard and relatively brittle state into a molten or rubber-like state which allows the thermoplastic resin to flow into the pores of the porous reinforcing layer 208. Pressure may be applied to the top surface of the reinforcing layer 208 to improve bonding. Subsequently, the polymer laminate 200 may be cooled to solidify the bonds between the polymer film 204 and the reinforcing layer 208. The polymer laminate 200 may undergo additional heating and/or compression steps to improve bonding. In some aspects, a vacuum may also be applied to facilitate further bonding of the reinforcing layer 208 to the polymer film 204. In further aspects, ultrasonic or ultraviolet (UV) bonding may be used to first bond the reinforcing layer 208 to the polymer film 204 prior to heating of the polymer film 204.

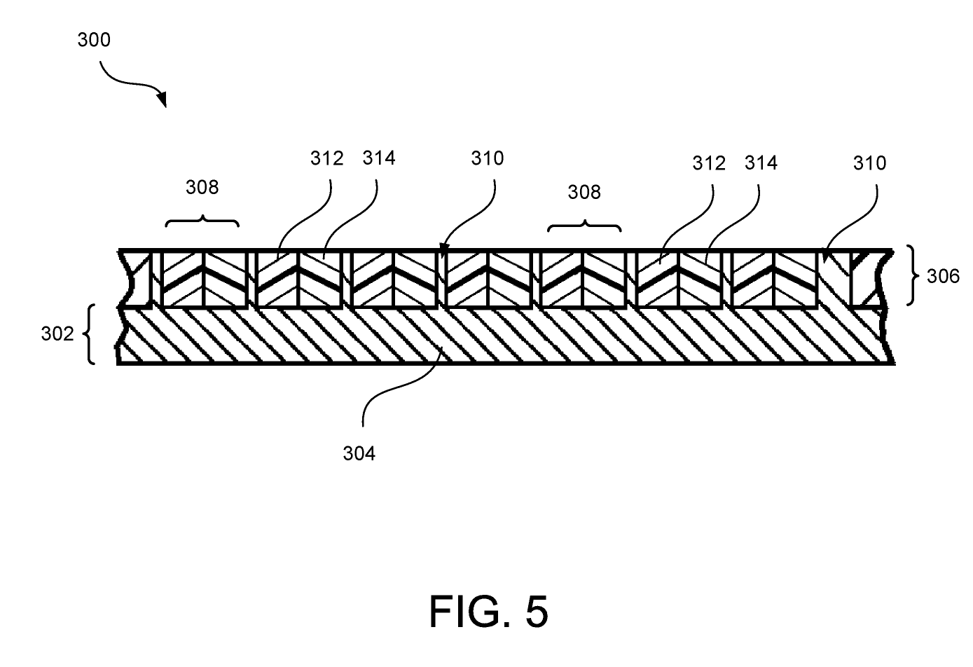

FIG. 5 illustrates a polymer laminate 300 according to another aspect of the present disclosure. Similar to the polymer laminate 200, the polymer laminate 300 may include a first layer 302 comprising a polymer film 304. The polymer material selected for the polymer film 304 may include any one of the thermoplastic resins disclosed above with respect to the polymer laminate 100. The polymer laminate 300 also includes a second layer 306 comprising a porous reinforcing layer 308 and the polymer film 304 may be further located within the pores 310 of the reinforcing layer 208. The porous reinforcing layer 308 may be a bicomponent material comprising a first material 312 and a second material 314. The bicomponent material may be a woven or non-woven, such as a knit, a veil, a paper, a felt, and the like. The materials selected for the bicomponent material may include any of the materials mentioned above including any of the thermoplastic resins, fibers, and fillers.

In one aspect, the bicomponent material is a woven and/or non-woven material made from carbon fiber and aramid fibers. The ratio between the carbon fiber and aramid fiber may be determined based on the intended use of the polymer laminate 300. For example, the bicomponent material may have 10%-90% carbon fiber and the remainder aramid fiber by weight, the bicomponent material may have 10% carbon fiber and 90% aramid fiber by weight, 20% carbon fiber and 80% aramid fiber by weight, 30% carbon fiber and 70% aramid fiber by weight, 40% carbon fiber and 60% aramid fiber by weight, 50% carbon fiber and 50% aramid fiber by weight, 60% carbon fiber and 40% aramid fiber by weight, 70% carbon fiber and 30% aramid fiber by weight, 80% carbon fiber and 20% aramid fiber by weight, and 90% carbon fiber and 10% aramid fiber by weight.

In a further aspect, the polymer laminate 300 may have a bicomponent carbon fiber and aramid fiber veil as the porous reinforcing layer 308 and a polyetherimide film as the polymer film 304. In a further aspect, the polymer laminate 300 may have a bicomponent carbon fiber and aramid fiber veil as the porous reinforcing layer 308 and a polyetherimide film as the polymer film 304 and the polymer laminate 300 may have an areal density of 40- 150 gsm.

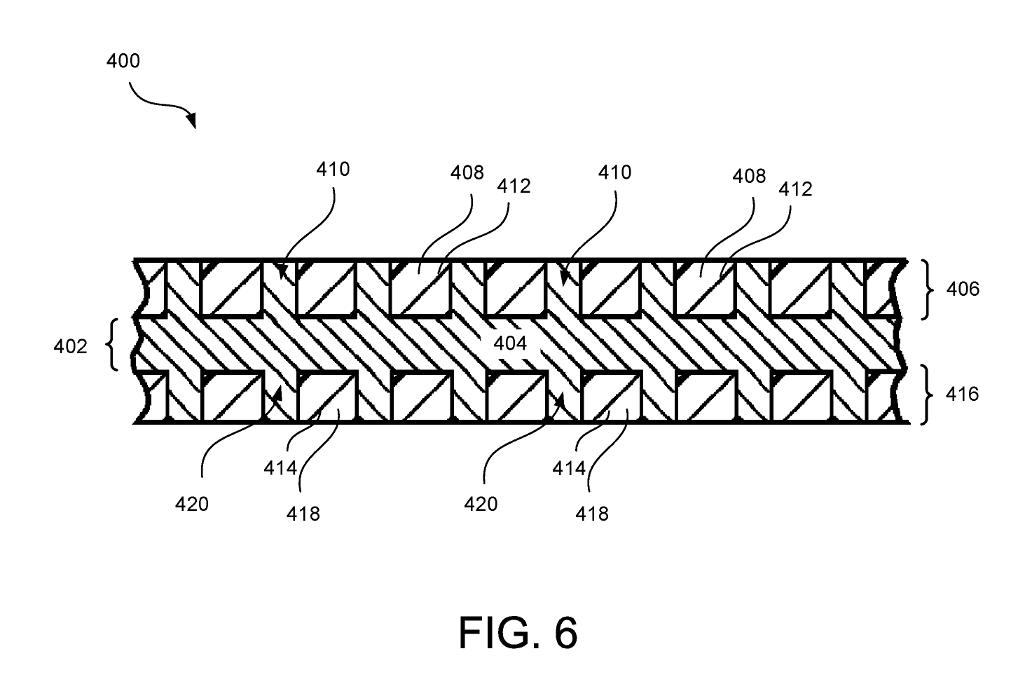

FIG. 6 illustrates a polymer laminate 400 according to another aspect of the present disclosure. Similar to the polymer laminate 200, the polymer laminate 400 may include a first layer 402 comprising a polymer film 404. The polymer material selected for the polymer film 404 may include any one of the thermoplastic resins disclosed above with respect to the polymer laminate 100. The polymer laminate 400 also includes a second layer 406 comprising a first porous reinforcing layer 408 made from a first material 412 and the polymer film 404 located within pores 410 of the first porous reinforcing layer 408. The polymer laminate 400 also includes a third layer 416 comprising a second porous reinforcing layer 418 made from a second material 414 and the polymer film 404 located with pores 420 of the second reinforcing layer 418. The materials selected for the first material 412 and second material 414 may include any of the materials mentioned above including any of the thermoplastic resins, fibers, and fillers.

In one aspect, the polymer film 404 may include polyetherimide (PEI), a second porous reinforcing layer 418 may include carbon fiber, and a third layer 416 may include aramid. In one aspect, the polymer laminate 400 may include a plurality of layers of the polymer film 404 that may include polyetherimide (PEI), a plurality of second porous reinforcing layers 418 that may include carbon fiber, and a plurality of the third layers 416 that may include aramid having a thickness up to 5 mm (millimeters).The first reinforcing layer 408 and second reinforcing layer 418 may have the same or different thickness and/or areal density depending on the intended application of the polymer laminate 400. In one aspect, the first reinforcing layer 408 may have an areal density of 10 gsm and the second reinforcing layer 418 may have an areal density of 15 gsm. In a further aspect, the first reinforcing layer 408 may be carbon fiber and the second reinforcing layer 418 may be aramid fiber. In a further aspect, the first reinforcing layer 408 may be carbon fiber with an areal density of 10 gsm and the second reinforcing layer 418 may be aramid fiber with an areal density of 15 gsm.

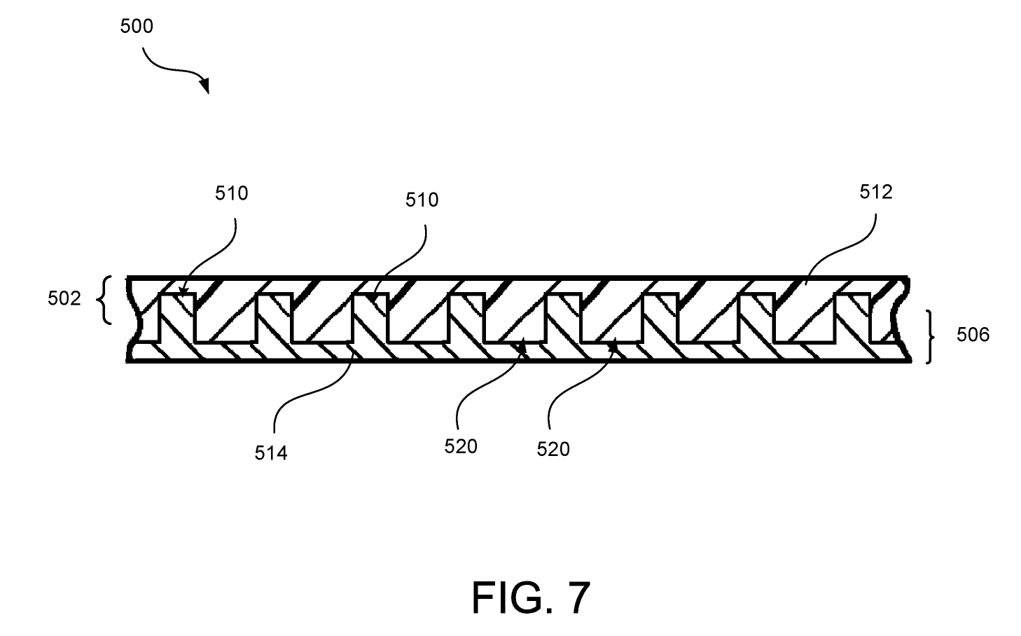

FIG. 7 illustrates a polymer laminate 500 according to another aspect of the disclosure. The polymer laminate 500 may be formed from a first layer 502 made from a first porous material 512 and a second layer 506 made from a second porous material 514, which may include the woven and non-woven materials described above. The first porous material 512 and the second porous material 514 may include any of the materials described above including the thermoplastic resins, fibers, nano-fibers, fillers, and the like. The first porous material 512 may be further located within pores 510 of the second porous material 514. The second porous material 514 may be located within pores 520 of the first porous material 512. In one aspect, the first porous material 512 may be a polyamide fabric and the second porous material 514 may be a polycarbonate fabric.

A polymer laminate is not limited to the disclosure above with respect to FIGS. 1-7. Additional combinations of polymer films and reinforcing layers are contemplated by the present disclosure. In the following examples, a polymer film may be denoted by A, a first reinforcing layer made from a first material may be denoted by B, and a second reinforcing layer made from a second material may be denoted by C. A polymer laminate may have layers with at least the following orientations: A/B, A/C, B/A/C, B/C/A, C/B/A, BC/A (where BC is a woven or non-woven bicomponent layer), BC/A/BC, A/B/A, A/BC/A, A/B/C/B/A, B/C/A/C/B, B/C/A/B/C, and the like.

By controlling exactly where individual layers are placed in the laminate, optimal property profiles can be obtained. Thinner than normal laminates can be made via use of nonwoven fabrics, which are based on the individual fiber thickness rather than collective yarn thickness as in woven fabrics. For ultimate strength, woven fabrics may be still used when the thickness is not critical to the application. For very thin material requirements, all components may be provided as fibers as a nonwoven fabric. Fibers that can form thinner layers than extrude films are available. To avoid adhesion problems, compatible materials can be included as fiber or film, to permit polymer melt or flow to bond with the substrates. Fabrics composed of high strength, high modulus thermoplastic fibers, and coated with or embedded in a more pliable matrix, will be more resistant to tearing than when a more rigid matrix is used. Use of high modulus reinforcing fibers may require alternate honeycomb formation procedure, including but not limited to slitting and folding.

Articles produced according to the disclosure include semi-structural panels for aircraft interiors, honeycomb cores for aircraft panels, flexible circuit boards, circuit boards, electronic components, transformer papers, filters, apparel including sport apparel, work apparel, military apparel, television screens including LED screens and plasma screens, luggage, flood control walls, cargo bins, prosthetic devices, wind turbine blades, sporting equipment, tents, thin layers for thermoplastic composites, electrical insulation paper, reinforcements for rigid article, stiffeners rigid articles, and medical equipment.

Articles according to the disclosure may also include skin layers for honeycomb or foam core panels, which may be used for structural or semi-structural purposes. One or more layers may be combined to form a composite laminate having an areal density of 50-500 gsm and desired strength and stiffness properties.

Articles produced according to the disclosure may also include, for example, components of computer and business machine housings, home appliances, trays, plates, handles, helmets, automotive parts such as instrument panels, cup holders, glove boxes, interior coverings and the like. In various further aspects, formed articles may also include, but are not limited to, components of food service items, medical devices, animal cages, electrical connectors, enclosures for electrical equipment, electric motor parts, power distribution equipment, communication equipment, computers and the like, including devices that have molded in snap fit connectors. In a further aspect, articles that may be produced according to the present disclosure may include components of exterior body panels and parts for outdoor vehicles and devices including automobiles, protected graphics such as signs, outdoor enclosures such as telecommunication and electrical connection boxes, and construction applications such as roof sections, wall panels and glazing.

Multilayer articles made of the disclosed polycarbonates particularly include articles which will be exposed to UV-light, whether natural or artificial, during their lifetimes, and most particularly outdoor articles; i.e., those intended for outdoor use. Suitable articles are exemplified by enclosures, housings, panels, and parts for outdoor vehicles and devices; enclosures for electrical and telecommunication devices; outdoor furniture; aircraft components; boats and marine equipment, including trim, enclosures, and housings; outboard motor housings; depth finder housings, personal water-craft; jet-skis; pools; spas; hot-tubs; steps; step coverings; building and construction applications such as glazing, roofs, windows, floors, decorative window furnishings or treatments; treated glass covers for pictures, paintings, posters, and like display items; wall panels, and doors; protected graphics; outdoor and indoor signs; enclosures, housings, panels, and parts for automatic teller machines (ATM); enclosures, housings, panels, and parts for lawn and garden tractors, lawn mowers, and tools, including lawn and garden tools; window and door trim; sports equipment and toys; enclosures, housings, panels, and parts for snowmobiles; recreational vehicle panels and components; playground equipment; articles made from plastic-wood combinations; golf course markers; utility pit covers; computer housings; desk-top computer housings; portable computer housings; lap-top computer housings; palm-held computer housings; monitor housings; printer housings; keyboards; facsimile machine housings; copier housings; telephone housings; mobile phone housings; radio sender housings; radio receiver housings; light fixtures; lighting appliances; network interface device housings; transformer housings; air conditioner housings; cladding or seating for public transportation; cladding or seating for trains, subways, or buses; meter housings; antenna housings; cladding for satellite dishes; coated helmets and personal protective equipment; coated synthetic or natural textiles; coated photographic film and photographic prints; coated painted articles; coated dyed articles; coated fluorescent articles; coated articles; and like applications.

In a further aspect, the article including the laminate materials can be used in automotive applications. In a yet further aspect, the article includes the laminate materials can be selected from instrument panels, overhead consoles, interior trim, center consoles, panels, quarter panels, rocker panels, trim, fenders, doors, deck lids, trunk lids, hoods, bonnets, roofs, bumpers, fascia, grilles, minor housings, pillar appliqués, cladding, body side moldings, wheel covers, hubcaps, door handles, spoilers, window frames, headlamp bezels, headlamps, tail lamps, tail lamp housings, tail lamp bezels, license plate enclosures, roof racks, and running boards. In an even further aspect, the article including the laminate materials can be selected from mobile device exteriors, mobile device covers, enclosures for electrical and electronic assemblies, protective headgear, buffer edging for furniture and joinery panels, luggage and protective carrying cases, small kitchen appliances, and toys.

In one aspect, the parts can include electrical or electronic devices including the laminate materials. In a further aspect, the electrical or electronic device can be a cellphone, a MP3 player, a computer, a laptop, a camera, a video recorder, an electronic tablet, a pager, a hand receiver, a video game, a calculator, a wireless car entry device, an automotive part, a filter housing, a luggage cart, an office chair, a kitchen appliance, an electrical housing, an electrical connector, a lighting fixture, a light emitting diode, an electrical part, or a telecommunications part.

It will be appreciated that the present disclosure may include any one and up to all of the following examples.

Example 1: A polymer laminate comprising: a first layer having a first surface and a second surface, the first layer comprising a first non-porous polymer material; and a second layer on the first surface of the first layer, the second layer comprising: a first porous polymer material defining a first plurality of pores; and the first non-porous polymer material located within the first plurality of pores.

Example 2: The polymer laminate of Example 1, wherein the first porous polymer material is at least one of the following: a woven polymer, a knit polymer, a veil, a paper, and a felt.

Example 3: The polymer laminate of any one of Examples 1-2, wherein the first non-porous polymer material is a film that includes at least one of the following: polycarbonate, polyetherimide, polystyrene, polyethylene, polyphenylene ether, polypropylene, polyether ketone, polyether ether ketone, and a polyester.

Example 4: The polymer laminate of any one of Examples 1-3, wherein the first porous polymer material comprises at least one of the following: carbon fibers, aramid fibers, glass fibers, polyester fibers, nylon fibers, and natural fibers.

Example 5: The polymer laminate of any one of Examples 1-4, wherein the first non-porous polymer material comprises a polycarbonate film and the first porous polymer material comprises a polyamide fabric.

Example 6: The polymer laminate of any one of Examples 1-4, wherein the first non-porous polymer material is a polycarbonate film and the first porous polymer material comprises aromatic polyester fibers.

Example 7: The polymer laminate of any one of Examples 1-4, wherein the first porous polymer material is a bicomponent veil.

Example 8: The polymer laminate of Example 7, wherein the bicomponent veil comprises carbon fiber and aramid fiber.

Example 9: The polymer laminate of any one of Examples 1-8, further comprising a third layer on the second surface of the first layer, the third layer comprising: a second porous polymer material defining a second plurality of pores;

and the first non-porous polymer material located within the second plurality of pores.

Example 10: The polymer laminate of Example 9, wherein the first non-porous polymer material is a polyetherimide film, the first porous polymer material comprises carbon fibers, and the second porous polymer material comprises aramid fibers.

Example 11: A method for manufacturing a polymer laminate comprising: arranging a first layer having a first surface and a second surface, the first layer comprising a first non-porous polymer material; arranging a second layer on the first surface of the first layer, the second layer comprising a first porous polymer material defining a first plurality of pores; heating the first layer to a temperature above a glass transition temperature of the first non-porous polymer material; applying pressure to the first surface of the first layer; and filling the first plurality of pores with the first non-porous polymer material.

Example 12: The method of Example 11, wherein the first porous polymer material is at least one of the following: a woven polymer, a knit polymer, a veil, a paper, and a felt.

Example 13: The method of any one of Examples 11-12, wherein the first non-porous polymer material is a film that includes at least one of the following: polycarbonate, polyetherimide, polystyrene, polyethylene, polyphenylene ether, polypropylene, polyether ketone, polyether ether ketone, and a polyester.

Example 14: The method of any one of Examples 11-13, wherein the first porous polymer material comprises at least one of the following: carbon fibers, aramid fibers, glass fibers, polyester fibers, nylon fibers, and natural fibers.

Example 15: The method of any one of Examples 11-14, wherein the first non-porous polymer material comprises a polycarbonate film and the first porous polymer material comprises a polyamide fabric.

Example 16: The method of any one of Examples 11-15, wherein the first non-porous polymer material is a polycarbonate film and the first porous polymer material comprises aromatic polyester fibers.

Example 17: The method of any one of Examples 11-15, wherein the first porous polymer material is a bicomponent veil, and wherein the bicomponent veil comprises carbon fiber and aramid fiber.

Example 18: The method of any one of Examples 11-15, further comprising: arranging a third layer on the second surface of the first layer, the third layer comprising a second porous polymer material defining a second plurality of pores such that the second plurality of pores are filled with the first non-porous polymer material, wherein the first non-porous polymer material is a polyetherimide film, the first porous polymer material comprises carbon fibers, and the second porous polymer material comprises aramid fibers.

Example 19: A polymer laminate comprising: a first layer comprising a first porous polymer material defining a first plurality of pores; and a second layer comprising a second porous polymer material defining a second plurality of pores, wherein the first porous polymer material is located within the second plurality of pores, and wherein the second porous polymer material is located within the first plurality of pores.

Example 20: The polymer laminate of Example 19, wherein the first porous polymer material is a polycarbonate fabric and the second porous polymer material is a polyamide fabric.

Each of these non-limiting examples can stand on its own, or can be combined in various permutations or combinations with one or more of the other examples.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

The above detailed description includes references to the accompanying drawings, which form a part of the detailed description. The drawings show, by way of illustration, specific aspects in which the disclosure can be practiced. These aspects are also referred to herein as “examples.” Such examples can include elements in addition to those shown or described. However, the present disclosure also contemplates examples in which only those elements shown or described are provided. Moreover, the present disclosure also contemplates examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other aspects can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed aspect. Thus, the following claims are hereby incorporated into the Detailed Description as examples or aspects, with each claim standing on its own as a separate aspect, and it is contemplated that such aspects can be combined with each other in various combinations or permutations. The scope of the disclosure should be determined with reference to the appended claims, along with the full scope of equivalents to which such claims are entitled.

1. A polymer laminate comprising:
a first layer having a first surface and a second surface, the first layer comprising a first non-porous polymer material; and
a second layer on the first surface of the first layer, the second layer comprising:
a first porous polymer material defining a first plurality of pores; and
the first non-porous polymer material located within the first plurality of pores.

2. The polymer laminate of claim 1, wherein the first porous polymer material is at least one of the following: a woven polymer, a knit polymer, a veil, a paper, and a felt.

3. The polymer laminate of claim 1, wherein the first non-porous polymer material is a film that includes at least one of the following: polycarbonate, polyetherimide, polystyrene, polyethylene, polyphenylene ether, polypropylene, polyether ketone, polyether ether ketone, and a polyester.

4. The polymer laminate of claim 1, wherein the first porous polymer material comprises at least one of the following: carbon fibers, aramid fibers, glass fibers, polyester fibers, nylon fibers, and natural fibers.

5. The polymer laminate of claim 1, wherein the first non-porous polymer material comprises a polycarbonate film and the first porous polymer material comprises a polyamide fabric.

6. The polymer laminate of claim 1, wherein the first non-porous polymer material is a polycarbonate film and the first porous polymer material comprises aromatic polyester fibers.

7. The polymer laminate of claim 1, wherein the first porous polymer material is a bicomponent veil.

8. The polymer laminate of claim 7, wherein the bicomponent veil comprises carbon fiber and aramid fiber.

9. The polymer laminate of claim 1, further comprising a third layer on the second surface of the first layer, the third layer comprising:
a second porous polymer material defining a second plurality of pores; and
the first non-porous polymer material located within the second plurality of pores.

10. The polymer laminate of claim 9, wherein the first non-porous polymer material is a polyetherimide film, the first porous polymer material comprises carbon fibers, and the second porous polymer material comprises aramid fibers.

11. A method for manufacturing a polymer laminate comprising:
arranging a first layer having a first surface and a second surface, the first layer comprising a first non-porous polymer material;
arranging a second layer on the first surface of the first layer, the second layer comprising a first porous polymer material defining a first plurality of pores; heating the first layer to a temperature above a glass transition temperature of the first non-porous polymer material;
applying pressure to the first surface of the first layer; and
filling the first plurality of pores with the first non-porous polymer material.

12. The method of claim 11, wherein the first porous polymer material is at least one of the following: a woven polymer, a knit polymer, a veil, a paper, and a felt.

13. The method of claim 11, wherein the first non-porous polymer material is a film that includes at least one of the following: polycarbonate, polyetherimide, polystyrene, polyethylene, polyphenylene ether, polypropylene, polyether ketone, polyether ether ketone, and a polyester.

14. The method of claim 11, wherein the first porous polymer material comprises at least one of the following: carbon fibers, aramid fibers, glass fibers, polyester fibers, nylon fibers, and natural fibers.

15. The method of claim 11, wherein the first non-porous polymer material comprises a polycarbonate film and the first porous polymer material comprises a polyamide fabric.

16. The method of claim 11, wherein the first non-porous polymer material is a polycarbonate film and the first porous polymer material comprises aromatic polyester fibers.

17. The method of claim 11, wherein the first porous polymer material is a bicomponent veil, and wherein the bicomponent veil comprises carbon fiber and aramid fiber.

18. The method of claim 11, further comprising:
arranging a third layer on the second surface of the first layer, the third layer comprising a second porous polymer material defining a second plurality of pores such that the second plurality of pores are filled with the first non-porous polymer material,
wherein the first non-porous polymer material is a polyetherimide film, the first porous polymer material comprises carbon fibers, and the second porous polymer material comprises aramid fibers.

19. A polymer laminate comprising:
a first layer comprising a first porous polymer material defining a first plurality of pores; and
a second layer comprising a second porous polymer material defining a second plurality of pores,
wherein the first porous polymer material is located within the second plurality of pores, and
wherein the second porous polymer material is located within the first plurality of pores.

20. The polymer laminate of claim 19, wherein the first porous polymer material is a polycarbonate fabric and the second porous polymer material is a polyamide fabric.
